(19) United States
(12) Patent Application Publication
(10) Pub. No.: US 2007/0052614 A1
(43) Pub. Date: Mar. 8, 2007

(54) Tapered fiber optic bundle metadisplay

(76) Inventor: Steven Michael Zimmerman, Beacon, NY (US)

Correspondence Address: EPSTEIN DRANGEL BAZERMAN & JAMES, LLP, 60 EAST 42ND STREET, SUITE 820, NEW YORK, NY, 10165, US

(21) Appl. No.: 11/439,014

(22) Filed: May 23, 2006

Related U.S. Application Data
(60) Provisional application No. 60/684,633, filed on May 24, 2005.

(51) Int. Cl. G09G 5/00

(52) U.S. Cl. 345/1.1

(57) ABSTRACT

A metadisplay comprising a plurality of subdisplays, each subdisplay comprising a microdisplay for displaying a subimage, and FTFOB having an FTFOB entrance end and an FTFOB exit end, wherein said entrance end is optically coupled to said microdisplay for transmitting said subimage from said entrance end to said exit end, whereby said exit end provides a subdisplay face with said subimage.

The present application claims the benefit of U.S. provisional patent application No. 60/684,633, filed May 24, 2005.

### BACKGROUND OF THE INVENTION

1. Field of the Invention

The present invention relates to video displays. More specifically, it relates to combining a plurality of smaller (micro)displays to make one larger (meta)display.

2. Description of Prior Art Including Information Disclosed Under 37 CFR 1.97 and 1.98

Information relevant to attempts to address these problems can be found in U.S. Pat. Nos. 4,299,447 to Soltan, et al; 6,304,703 to Lowry; 6,618,529 to Lowry. However, each one of these references suffers from one or more of the following disadvantages: mechanical complexity, necessity for an elaborate frame structure; lack of integration between the image source and driving electronics, difficulty in easily and permanently aligning the signal source (e.g. the microdisplay) with the optics.

### BRIEF SUMMARY OF THE INVENTION

Miniature displays, a.k.a. “microdisplays” are discussed in U.S. Pat. No. 5,920,080 and others assigned to “FED Corporation” and/or to its successor, “Emagin Corporation” (assignee of the present application) and hereby incorporated by reference). Microdisplays, which comprise OLEDs, are fabricated like silicon computer chips, “wafers” of single crystal silicon. The organic light-emitting diode (OLED) itself is integrated with its display electronics in a kind of microdisplay “chip”. Each silicon “wafer” may have on the order of one hundred microdisplay chips, arranged like cookies on a baking sheet. These chips have at the center of their surface an “active area” which may comprise an active light-emitting device such as an OLED. This active area is surrounded by an area which does not emit light or images, which may comprise electronics, and which forms a sort of a border around the active area. It is this border which prevents simply “tiling” the microdisplays, i.e. placing them adjacent one another in a large mosaic-like array, to form a larger display. Heretofore this had proved difficult, impossible, or infeasible.

However, in accordance with the system according to the present invention, a plurality of small, high-resolution microdisplays can be combined to provide a large high-resolution image, such as would ordinarily be obtainable only from a large single microdisplay.

A large composite metadisplay face, displaying a metaimage, is realized by “tiling” a plurality of smaller subdisplay faces, each displaying the subimage at the exit end of a fused fiber optic bundle, the entrance end of which is optically coupled to a microdisplay; together these constitute a subdisplay. (Bundles of optical fibers, like individual optical fibers, are said to have an “entrance” end (where light enters the fiber) and an “exit” end (where light leaves the fiber), as is well known to those of ordinary skill in the relevant art.) By having the fused fiber optic bundle “tapered”, i.e. by making the entrance end and exit end areas of different sizes, the microdisplay's image (sometimes referred to herein as the subdisplay's subimage) passing through the FTFOB may be magnified (when the exit end area>the entrance end area) by the fused tapered fiber optic bundle (hereinafter sometimes referred to a FTFOB). The FTFOB exit ends may be brought into abutment to together form, from the subdisplay faces, a larger “metadisplay”. The metadisplay has a single surface, which may be planar, or, alternatively, may be milled into one of a variety of shapes,—e.g., concave, convex, or any arbitrary surface. The single metadisplay surface displays a single metaimage composed of the many subimages of the many subdisplays.

A smaller microdisplay can provide a larger image in accordance with the system according to the present invention, in which an image to be displayed (sometimes called a “subject image”; e.g. a single frame of film, depicting a scene), is separated into a total of n×m image parts (called “subimages”) for display on an n×m array of microdisplays, where n is the number of microdisplays in each row, and m is the number of microdisplays in each column, and each (“subimage”) is displayed on a separate microdisplay. Together these subimages make up a “metaimage” in a fashion reminiscent of the way the pieces of a jigsaw puzzle together make up the jigsaw puzzle picture. However, unlike each piece of a jigsaw puzzle, which each has a subimage across its entire surface (i.e. it has no frame or border, with the image going right to the edge of the piece), each microdisplay chip has the subimage across only part of its surface, the rest of the surface being taken up with a physical border, which may comprise, e.g. driver electronics, etc. Thus, the subimages cannot be placed into adjacency simply by placing the microdisplay chips into adjacency, and merely putting the microdisplay chips into adjacency would leave the borders abutting, with a big border separating each subimage. To bring the subimages into adjacency without borders between them, the subimages are brought into adjacency by having the image brought into a kind of light pipe (an FTFOB, discussed elsewhere herein) which has two ends, one of which is optically coupled to the active are of a microdisplay, and the other end of which displays the subimage, without any border, so that it may be brought into adjacency with the subimages found on the end of the other light pipes. As will discussed later herein, each light pipe may in some embodiments optically enlarge to a size greater than that of the microdisplay producing it, to a size equal to or even greater than the area of the microdisplay, thus allowing the display of adjacent images from adjacent (or abutting) microdisplays, even though the active areas on the adjacent microdisplays are not themselves adjacent (or abutting).

Each microdisplay chip is therefore fashioned into what is termed a “subdisplay”, which comprises (i) a microdisplay chip containing an OLED capable of providing a subimage, the OLED being at least optically and sometimes also directly physically coupled to a the entrance end of a Fused Tapered Fiber Optic Bundle (FTFOB) which Conducts the image, and, in some embodiments, also enlarges it.

It is not intended that the invention be summarized here in its entirety. Rather, further features, aspects and advantages of the invention are set forth in or are apparent from the following description and drawings.

### BRIEF DESCRIPTION OF THE DRAWINGS

To the preceding, and to such other objects that may hereinafter appear, the present invention relates to a video display, as set forth in detail in the herein specification and recited in the annexed claims, taken together with the accompanying drawings, wherein like numerals refer to like parts and in which:

FIG. 1 is a front view of metadisplay 100 showing the composite metadisplay face 110 with metaimage 400 and subdisplay faces 202, 204, 206, and 208 of subdisplays 200S, 205S, 210S, and 215S, respectively.

FIG. 2 is a side view of the device of FIG. 1 showing, inter alia, in more detail the structure and layout of the subdisplays 200S, 205S, (210S, and 215S not shown for clarity), i.e. showing fused tapered fiber optic bundles (FTFOBs) 200F, 205F, (210F and 215F not shown for clarity), respectively.

FIG. 3 is the view of FIG. 1 with the FTFOBs removed, showing in more detail the structure and layout of the subdisplays behind the face of the metadisplay.

FIG. 4 is a side view similar to FIG. 2, but which shows an exemplary alternative embodiment showing a metadisplay face with a concave surface.

### DETAILED DESCRIPTION OF THE PREFERRED EMBODIMENTS

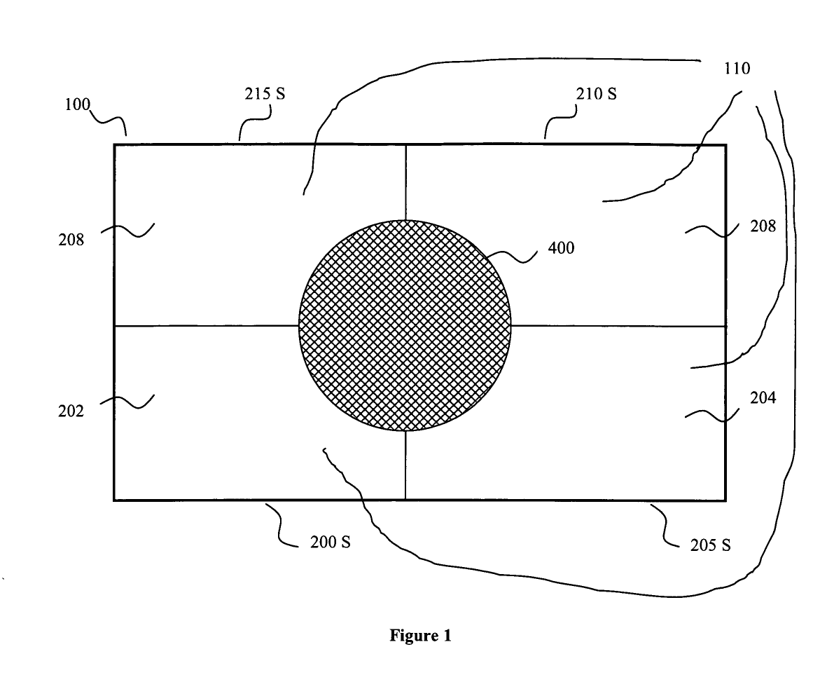

Reference is now made to FIG. 1, a front view which shows metadisplay 100 and metadisplay face 110, which comprises the subdisplay faces 202, 204, 206, and 208 (a.k.a. the ends of fused tapered fiber optic bundle ends 202, 204, 206, and 208) of subdisplays 200S, 205S, 210S, and 215S (respectively).

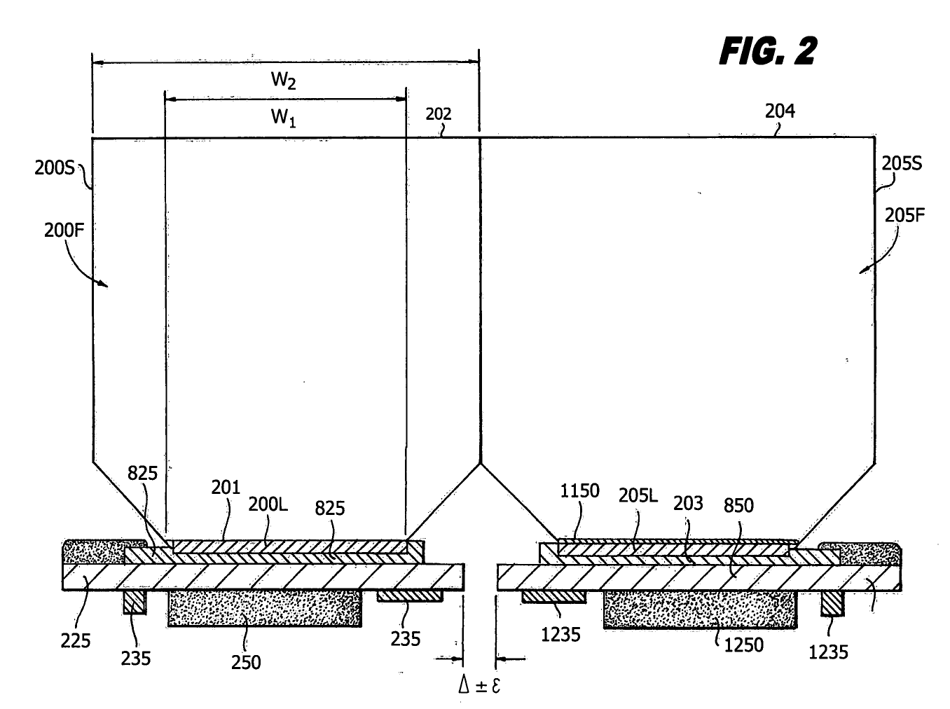

Reference is now made to FIG. 2, which is a side view of FIG. 1, giving a side view of the metadisplay 100. Subdisplays 200S and 205S have as their subimage source OLEDs 200L and 205L, respectively, which are coupled to FTFOBs 200F and, 205F, respectively. (Note further that a description of these fused tapered fiber optic bundles (FTFOBs) may be found in U.S. Pat. No. 5,303,373 (hereby incorporated by reference). FTFOBs are commercially available, e.g. from the Schott Optical company of Sturbridge, Mass. An FTFOB, is, as its name indicates, a bundle of optical fibers, effectively fused together along their length into one large fiber, and tapered so that the fiber bundle's two ends are of different sizes. This general type of “tapered fused fiber optic bundle” a.k.a. “fused tapered fiber optic bundle” is used to implement the system according to the present invention.

Reference is now made to FIG. 2, which is a side view of FIG. 1, giving a side view of the metadisplay 100. In particular, FIG. 2 shows subdisplays 200S and 205S, including (respectively) FTFOB 200F and FTFOB 205F, and the structure beneath each.

Subdisplay 200S comprises FTFOB 200F, which in turn comprises FTFOB 200F entrance end 201 (which has a width indicated as W₁) and FTFOB 200F exit end 202 (which has a width indicated as W₂). As previously explained, an image present at the FTFOB 200F entrance end 201 will appear at the FTFOB 200F exit end 202, in a width equal to the original width magnified by the factor (W₂/W₁) FTFOB 200F entrance end 201 is both optically coupled and physically coupled to OLED 200L, which itself is integral with silicon chip 825, which is mounted on Printed Circuit Board (PCB) 225. Also mounted on PCB 225 are surface-mount PCB components 235 and video driver connector 250. Note that each OLED active area, e.g. the OLED active areas of OLEDs 200L and 205L, are overlying larger printed circuit boards (PCBs) 225 and 1225.

Subdisplay 205S is similar to subdisplay 200S, in that it comprises FTFOB 205F, which in turn comprises FTFOB 205F entrance end 203 (which has a width indicated as W₁) and FTFOB 205F exit end 204 (which has a width indicated as W₂). (Of course, FTFOB 205 also has a “depth” which is into the page of the drawing, and is not shown for clarity of the drawing; it is understood that magnification, etc. in the “depth” dimension occurs in a fashion similar to how it does in the “width” dimension.) Subdisplay 105S differs from subdisplay 200S in that, to illustrate an alternative embodiment according to the present invention, FTFOB 205F has a Fused Fiber Optic Faceplate (“faceplate”) 1150 between it and OLED 205L, so that FTFOB 205F is physically coupled to faceplate 1150, which is physically coupled to OLED 205L, thereby optically coupling OLED 205L to FTFOB 205F. Of course, OLED 205L is integral with silicon chip 850, which is mounted on Printed Circuit Board (PCB) 1225. Fused Fiber Optic Faceplate (“faceplate”) 1150 is similar to an FTFOB, but without the taper, and is of a type readily available from the Schott optical company of Southbridge, Mass., USA.

Faceplate 1150, which has advantages including that it protects OLED 205L during assembly, may be held in place with a suitable optical adhesive. (For illustrative purposes, FIG. 2 shows subdisplay 200S without a faceplate, but shows subdisplay 205S with a faceplate (1150); it should be understood that, in a typical application, a faceplate is likely to be used either on all subdisplays, or on none.

Whether or not a faceplate is used, there is an interior space, labeled “Δ±ε”, between the edges of any adjacent PCBs, e.g. PCB 225 and PCB 1225 This space Δ±ε is required to allow adjustment of each OLED's active area to precisely match the input face of the taper, as such adjustment may be needed to allow for tolerances in the components and assembly of the display.

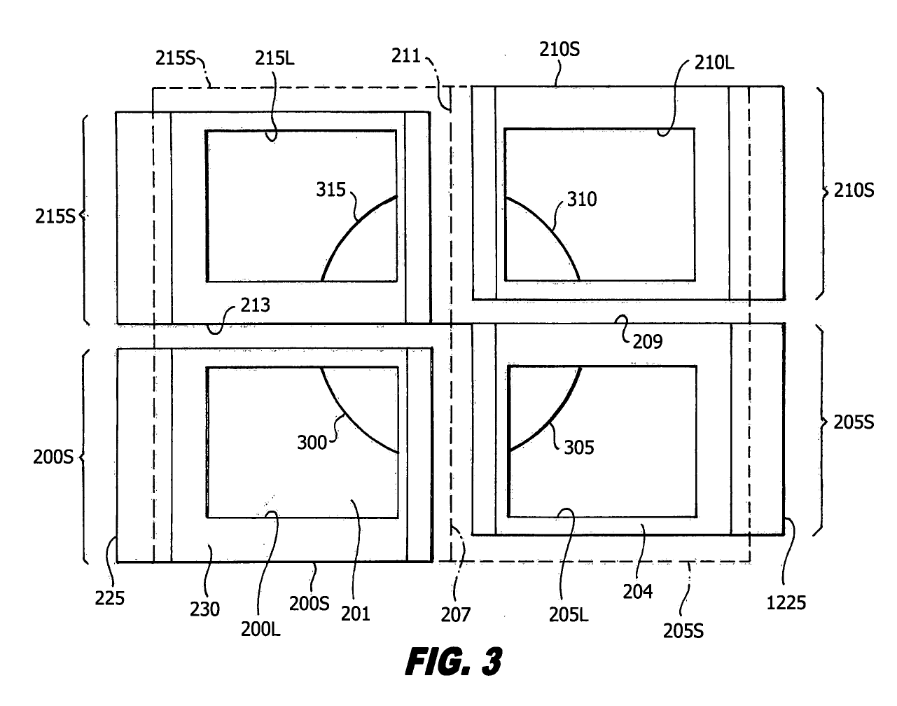

Reference is now made to FIG. 3, which is a view of FIG. 1 with the FTFOBs 200F, 205F, 210F, 215F of subdisplays 200S, 205S, 210S, and 215S removed, showing in more detail and in top view the outline of the structure underlying the subdisplays 200S, 205S, 210S, and 215S of the metadisplay 100.

The faces of subdisplays 200S and 205S (a.k.a. exit ends 201 and 204) of FTFOBs 200F and 205F, are in tight abutment, as shown, for example, at abutment lines 204, 207, 211, and 213. This close abutment is achieved by proper shaping of the FTFOBs, e.g. by cutting them so that the fibers illuminated at the edges of adjacent displays, e.g. at edges 291 and 292 of 200L and 205L, respectively (FIG. 2) abut in very close proximity at the top of the FTFOBs (e.g. at abutment line 207).

Note that subdisplays 200S, 205S, 210S and 215S have subimages 300, 305, 310, and 315, respectively, displayed on OLEDs 200L, 205L, 210L and 215L, also respectively. Note further that each of these subimages is a quarter of a circle, and that, together, these subimages compose the full circle of metaimage 400 (FIG. 1).

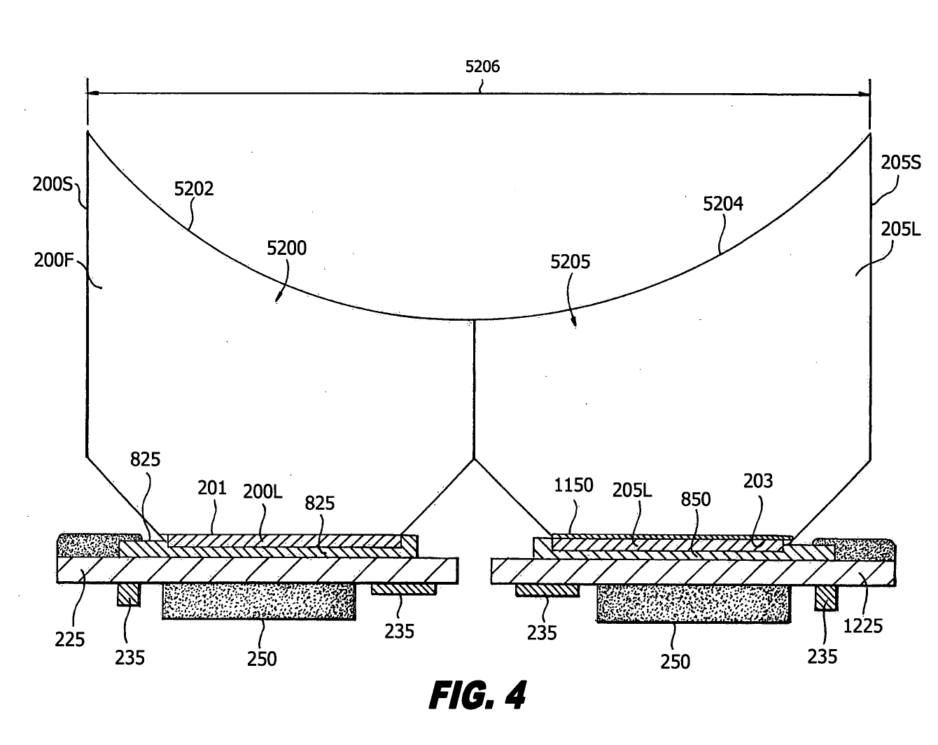

Reference is now made to FIG. 4, which is a view similar to that of FIG. 2, but which depicts an alternative embodiment in which the exit surfaces 5201 and 5204 of fiber taper 5200 and fiber taper 5205 (respectively) have been shaped (via machining, milling, chamfering, polishing, and/or any other suitable process) to make a single continuous, arbitrary surface 5206. (While in this illustrative example the single continuous, arbitrary surface 5206 is concave, it should be readily understood that the surface could be of any arbitrary shape, whether concave, convex, irregular, flat, etc.) The alternative embodiment of FIG. 4 is in all other respects similar to that of FIGS. 1-3, discussed above.

Although illustrative embodiments of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims. For example, although for illustrative purposes a metadisplay has been shown to comprise a small number of subdisplays, e.g. four (4) subdisplays arranged in a 2×2 tiling, it will be readily apparent to the reader and to those of ordinary skill in the relevant arts that the metadisplay may comprise a larger number of subdisplays or a fewer number than illustrated here, as the invention is scalable. (Indeed tiling patterns may also vary, e.g. long and narrow 1×n, square n×n, rectangular n×m, or irregular, depending on what aspect ratio or display shape is desired.)

1. A metadisplay comprising a plurality of subdisplays, each subdisplay comprising:
a microdisplay for displaying a subimage, and
an FTFOB having an FTFOB entrance end and an FTFOB exit end,
wherein said entrance end is optically coupled to said microdisplay for transmitting said subimage from said entrance end to said exit end, whereby said exit end provides a subdisplay face with said subimage.

2. The metadisplay of claim 1, wherein at least two of said plurality of said subdisplays have said subdisplay faces in close proximity.

3. The metadisplay of claim 1, wherein each of said plurality of subdisplays has said subdisplay face proximate to said subdisplay face of at least one other of said plurality of subdisplays.

4. The metadisplay of claim 3, further comprising a composite metadisplay face, said composite metadisplay face comprising substantially all of said subdisplay faces.

5. The metadisplay of claim 4, wherein said composite metadisplay face displays a metaimage comprising said subimage displayed on each of said plurality of subdisplays.

6. The metadisplay of claim 5, wherein said composite metadisplay face is substantially planar in extent.

7. The metadisplay of claim 5, wherein said composite metadisplay face is substantially concave in extent.

8. The metadisplay of claim 5, wherein said composite metadisplay face is substantially convex in extent.

9. The metadisplay of claim 5, wherein said composite metadisplay face is substantially of an arbitrary surface contour in extent.

10. A metadisplay comprising a plurality of subdisplays, each subdisplay comprising:
a microdisplay for displaying a subimage, and
an FTFOB having an FTFOB entrance end and an FTFOB exit end,
wherein the area of said FTFOB entrance end is greater than the area of said FTFOB exit end, and
wherein said entrance end is optically coupled to said microdisplay for transmitting said subimage from said entrance end to said exit end, whereby said exit end provides a subdisplay face with said subimage.

11. The metadisplay of claim 10, wherein at least two of said plurality of said subdisplays have said subdisplay faces in close proximity.

12. The metadisplay of claim 10, wherein each of said plurality of subdisplays has said subdisplay face proximate to said subdisplay face of at least one other of said plurality of subdisplays.

13. The metadisplay of claim 12, further comprising a composite metadisplay face, said composite metadisplay face comprising substantially all of said subdisplay faces.

14. The metadisplay of claim 13, wherein said composite metadisplay face displays a metaimage comprising said subimage displayed on each of said plurality of subdisplays.

15. The metadisplay of claim 14, wherein said composite metadisplay face is substantially planar in extent.

16. The metadisplay of claim 14, wherein said composite metadisplay face is substantially concave in extent.

17. The metadisplay of claim 14, wherein said composite metadisplay face is substantially convex in extent.

18. The metadisplay of claim 14, wherein said composite metadisplay face is substantially of an arbitrary surface contour in extent.

19. A metadisplay comprising a plurality of subdisplays, each subdisplay comprising:
a microdisplay for displaying a subimage, and
an FTFOB having an FTFOB entrance end and an FTFOB exit end,
wherein the area of said FTFOB entrance end is greater than the area of said FTFOB exit end, and
wherein said entrance end is optically coupled to said microdisplay for transmitting said subimage from said entrance end to said exit end, whereby said exit end provides a subdisplay face with said subimage, further characterized in that at least two of said plurality of said subdisplays have said subdisplay faces in close proximity, and
further comprising a composite metadisplay face, said composite metadisplay face comprising said subdisplay faces and wherein said composite metadisplay face displays a metaimage comprising said subimage displayed on each of said plurality of subdisplays, and wherein said composite metadisplay face is substantially of an arbitrary surface contour in extent.

20. A metadisplay comprising a plurality of subdisplays, each subdisplay comprising:
a microdisplay for displaying a subimage, and
an FTFOB having an FTFOB entrance end and an FTFOB exit end,
wherein the area of said FTFOB entrance end is greater than the area of said FTFOB exit end, and
wherein said entrance end is optically coupled to said microdisplay for transmitting said subimage from said entrance end to said exit end, whereby said exit end provides a subdisplay face with said subimage, and wherein said optical coupling is achieved via optical coupling means comprising an optical faceplate, said optical faceplate being disposed between said microdisplay and said FTFOB entrance end.
